(19) United States
(12) Patent Application Publication
(10) Pub. No.: US 2007/0036322 A1
(43) Pub. Date: Feb. 15, 2007

(54) Network support for restricting wireline call terminations in a security risk area

(76) Inventors: Stuart Owen Goldman, Scottsdale, AZ (US); Richard E. Krock, Naperville, IL (US); Karl F. Rauscher, Emmaus, PA (US); James Philip Runyon, Wheaton, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/202,617

(22) Filed: Aug. 12, 2005

(51) Int. Cl. H04M 3/42

(52) U.S. Cl. 379/211.02; 379/88.17; 379/114.23

(57) ABSTRACT

A precautionary measure against wireline-device triggered bombs is described that restricts call terminations within a designated security risk area without shutting down an entire telephone office switch serving the affected area. Embodiments described herein provide for restricting wireline call terminations directed to a designated security risk area that are originated from non-privileged users, i.e., the general public, yet authorizing call terminations directed to the security risk area that are originated from privileged government users (e.g., GETS/WPS users). Call originations are permitted within the security risk area from both privileged and non-privileged users.

### CROSS-REFERENCE TO RELATED APPLICATIONS

This invention is related to U.S. patent application Ser. No. ______, titled “Network Support for Restricting Call Terminations in a Security Risk Area,” filed Jul. 22, 2005 and assigned to the assignee of the present invention.

### FIELD OF THE INVENTION

This invention relates generally to the field of telecommunication systems and, more particularly, to a system and methods for restricting call terminations in certain security risk areas.

### BACKGROUND OF THE INVENTION

Communication systems are well known in which persons may receive incoming calls (using, for example, a wireless or wireline phone) from other persons or devices calling the called party phone. Typically, the called party phone includes a “ringer” for playing a ring sequence or melody so as to alert the called party of the incoming call. Sadly, it is a known tactic of terrorist organizations to trigger bombs with wireless phones such that the ringing of the phone will detonate the bomb. Related patent application ______ described precautionary measures for responding to such threat. However, it is a concern that terrorists might also attempt to trigger bombings using wireline devices. It is conceivable that terrorists could rig any wireline device including, without limitation, traditional POTS phones or voice over IP (VoIP) phones to trigger a bomb upon receiving a call. This includes payphones, subscriber lines, Centrex lines and phones behind a Private Branch Exchange (PBX). Accordingly, there is a further need for precautionary measures to guard against the threat of wireline phone-triggered bombings.

Most particularly, the need for precautionary measures applies to certain security risk areas that are at a heightened risk of attack. For example, there are often threats against individual structures such as buildings, bridges or landmarks residing in a particular geographic area. A challenge faced by government and police authorities is to provide a level of protection for such areas that is sufficient, yet not overbroad so as to unduly disrupt the public. As an example of an overbroad approach, it is possible that one could shut down a central office telephone switch serving a particular security risk area to prevent wireline terminations, and hence prevent wireline phone triggered bombings in the area. However, central office switches generally serve large geographic areas and hence, shutting down the central office would cause significant disruption and confusion to the public. Moreover, shutting down the central office would effectively disable certain privileged users of the network such as police, fire or emergency personnel and/or government users from placing and receiving emergency calls to deal with the threat or actual disaster situation. In the United States, a nationwide Wireless Priority Service (WPS) provides priority treatment for privileged users in wireless networks. A complementary system, known as Government Emergency Telecommunications Service (GETS), provides priority treatment for privileged users in selected landline networks.

### SUMMARY OF THE INVENTION

The present invention provides systems and methods for guarding against wireline phone-triggered bombings while minimizing disruption to the general public as well as to government authorized callers. Embodiments of the invention provide for a terminating switch of a wireline network restricting wireline call terminations directed to a designated security risk area that are originated from non-privileged users, i.e., the general public, yet authorizing wireline call terminations in the security risk area originated from privileged government users. The terminating switch may comprise, for example and not limitation, a central office switch of the Public Switched Telephone Network (PSTN) or a VoIP switch.

In one embodiment, upon receiving an incoming wireline call directed to a called party device, a terminating switch determines a location of the called party device relative to a security risk area and determines whether the calling party is a privileged user (e.g., a WPS or GETS user). The terminating switch determines the location of the called party device based on its directory number, optionally by querying an Intelligent Network Service Control Point (SCP) or by independently consulting a database, such as a network database used for determining location of 9-1-1 callers. If the called party device is within the security risk area and the calling party is not a privileged user, the terminating switch prevents the incoming call from being completed thereby precluding the call from triggering a bomb. The terminating switch completes the call if the calling party is a privileged user or if the called party is not within the security risk area.

In another embodiment, in response to a determination that an emergency situation is present or imminent within a critical area defining a security risk area, a network operations center sends indicia of the emergency situation to one or more terminating switches to restrict wireline call terminations in the security risk area to non-privileged users but not restrict call terminations from privileged users.

In yet another embodiment, there is provided a system comprising means for identifying a security threat condition corresponding to a security risk area and alerting one or more switching elements of the threat condition; the one or more switching elements operable responsive to the threat condition to prevent wireline call terminations in the security risk area originated from non-privileged users but allow call terminations originated from privileged users.

In still another embodiment, there is provided an article comprising one or more computer-readable signal-bearing media. The media includes means for preventing wireline call terminations directed to a designated security risk area from non-privileged users and allow wireline call terminations directed to the security risk area from privileged users.

### BRIEF DESCRIPTION OF THE DRAWINGS

The foregoing and other advantages of the invention will become apparent upon reading the following detailed description and upon reference to the drawings in which:

FIG. 1 is a block diagram of a communication system defining an Intelligent Network architecture in which a terminating switch is coupled to an SCP;

FIG. 2 is a block diagram of a communication system including a terminating switch that does not rely on an SCP; and

FIG. 3 is a flowchart of a method exercised by a terminating switch in embodiments of the present invention to restrict call terminations directed to a designated security risk area.

### DESCRIPTION OF THE PREFERRED EMBODIMENT(S)

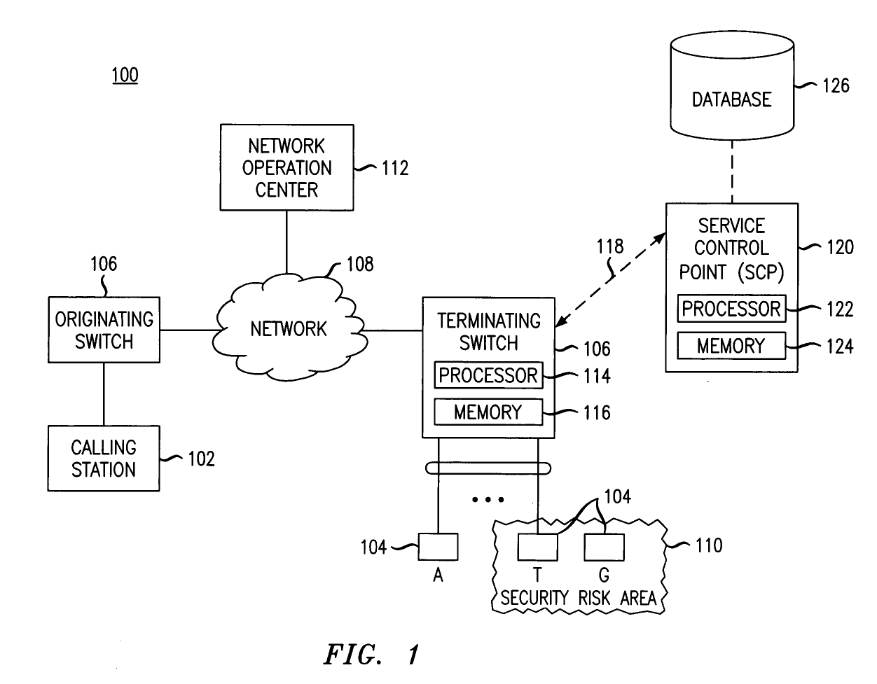

FIG. 1 depicts the basic architecture of a communication system 100 in which the present invention may be implemented. A plurality of user stations 102, 104 communicate with switching elements 106 residing, for example, at telephone or VoIP network central offices. The switching elements 106 may comprise, for example, 5ESS® or AUTOPLEX™ switching systems, available from Lucent Technologies, Inc. A network 108 comprising, for example and without limitation, the Public Switched Telephone Network (PSTN) or Internet Protocol (IP) network functionally connects the switching elements 106. For purposes of illustration, it is presumed user station 102 (“calling station”) has initiated a call to one of the user stations 104. The switching elements 106 on the originating and terminating side of the call are known as the originating and terminating switch, respectively. It is noted, however, calls directed to any of the user stations might be initiated and terminated at the same switch, as would be the case for a call from one user station 104 to another station 104. The present invention may be implemented in either scenario.

The calling station 102 may comprise any type of wireline or wireless phone or VoIP terminal. As is well known, the calling station dials or keys in a directory number of a called party station 104 to initiate a call. It is presumed the called party station 104 comprises a wireline terminal such as, for example and without limitation, a traditional POTS phone, voice over IP (VoIP) phone, pay phone, Centrex line, PBX line, fax or the like.

The called party station 104 may reside within or outside a designated security risk area 110. The security risk area 110 defines a geographic area that is at a heightened risk of attack, as may be determined from actual events or intelligence reports and the like. To best illustrate principles of the present invention, a plurality of prospective called party stations 104 are shown, including two stations denoted “T” and “G” residing in a designated security risk area 110 and another station denoted “A” residing outside of the security risk area 110. Station “T” defines a terminal called by a non-privileged user and terminal “G” defines a terminal called by a government authorized user. Among the stations residing in the security risk area 110, station T is presumed for precautionary purposes to be rigged to detonate a bomb (or at least presents a risk of detonating a bomb) when it receives an incoming call since a non-privileged user originated the call, whereas station G is presumed safe since the government authorized user has originated the call and presumably knows that station G is not rigged to detonate a bomb. Station A is presumed safe since it resides outside of the security risk area 110.

When a responsible authority such as, for example, the local or state police, the FBI, or other governmental agency has reason to believe that a bomb is within security risk area 110 that possibly might be remotely detonated by calling a called party station 104, a representative from such authority informs a network operations center 112 associated with the communications system 100. The network operations center 112 may comprise, for example, a regional command center operated by a service provider for the purpose of administering the network 100. The network operations center 112 upon affirming the identity of the authority and legitimacy of the received information, determines one or more terminating switches having a service area encompassing or overlapping the security risk area 102 and so informs the affected switches. In one embodiment, the act of informing an affected switch is accomplished by communicating an emergency condition indicator from the network operations center 112 to the switch coincident to normal call processing.

In one embodiment, the emergency condition indicator identifies in some manner a geographic boundary or locus of the security risk area 110. As will appreciated, a variety of techniques may be used to identify the security risk area. For example and without limitation, the security risk area 110 may be defined corresponding to the area of a particular telephone number area code and/or office code, zip code, civic address or X & Y coordinates.

As will be appreciated, the emergency condition indicator might further be augmented with additional instructions or information that the terminating switch may use to determine how to process the incoming call. For example, the emergency condition indicator might identify particular area codes and/or office codes of called stations for which the terminating switch need not restrict incoming calls or determine the location.

The terminating switch 106 includes a processor 114 and memory 116 for executing and storing software routines for processing and switching calls directed to the prospective called party stations 104. The terminating switch 106 communicates via link 118 comprising, for example, a Signaling System 7 (SS7) link with an adjunct platform known as a Service Control Point (SCP) 120. The SCP 120 includes a processor 122 and memory 124 for performing various call processing and switching services as may be requested by the terminating switch 106. This type of network configuration is known as an Intelligent Network and allows for at least a portion of call processing to be performed by the SCP 120 and hence decentralized off of the switch 106.

In one embodiment, the terminating switch 106 operates in conjunction with the SCP 120 to restrict call terminations in the security risk area 110 originated by non-privileged users (e.g., directed to station T), yet authorizing call terminations from privileged government users (e.g., directed to station G). In such manner, station T is precluded from ringing and detonating a bomb; yet the trusted station G (as well as station A residing outside of the security risk area 110) are allowed to both originate and terminate calls. In one embodiment, if an emergency condition is indicated for a particular terminating switch, the terminating switch 106 upon receiving an incoming-call directed to a called station 104 queries the SCP to determine the location of the called station. Responsive to the query, the SCP consults a network database 126 to determine the location of the called station.

In one embodiment, the database 126 comprises a mapping of various called party directory numbers to geographic location and hence, location of a particular called party may be determined based on its directory number. For example, the database may comprise an existing database adapted determining the location of 9-1-1 callers, and a reverse look-up may be performed using this existing data to determine the location of various called stations. Having determined the location of the called party, the terminating switch or SCP can determine whether the location is within a security risk area 110.

Thereafter, during such time as the emergency condition is in effect, the terminating switch operates to restrict call terminations in the security risk area. As noted, embodiments of the present invention provide for preventing call terminations from non-privileged users (e.g., directed to mobile station T), yet authorizing call terminations from privileged government users (e.g., directed to station G) in the security risk area 110. In one embodiment, the terminating switch determines that the incoming call is from a privileged user (e.g., a WPS or GETS call) from signaling information in the call request. The signaling information may comprise, for example, a GETS NS/EP indication in an incoming SS7 message or the WPS priority level.

As will be appreciated, when the emergency condition has passed and the threat of imminent bombings has-sufficiently diminished, and the network operations center 112 is so informed by a responsible authority, the network operations center 112 may send a network management command to the terminating switch specifying that the affected area is no longer a security risk area and call terminations may resume. The security area may also be expanded, reduced, or moved as needed.

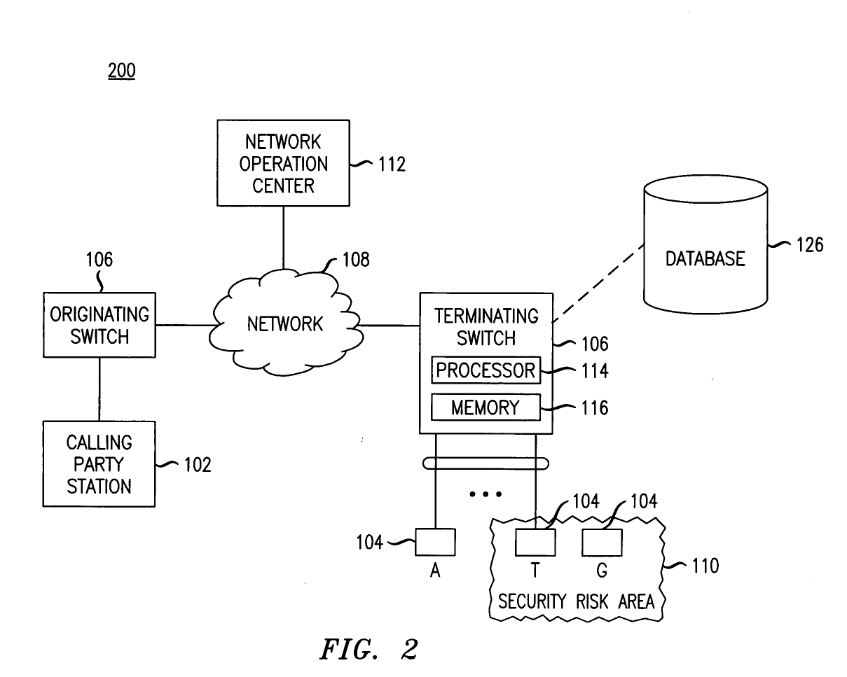

FIG. 2 depicts a communication system 200 in which the present invention may alternatively be implemented. The communication system 200 is substantially identical to the communication system 100, with the exception that the terminating switch does not rely an SCP to determine the location of the called station 104. Like -reference numerals are used to identify like elements in FIG. 1 and FIG. 2.

In the embodiment of FIG. 2, if an emergency condition is indicated for the terminating switch 106, the terminating switch upon receiving an incoming call directed to a called station 104 independently consults a network database 126 to determine the location of the called station. The network database comprises a mapping of various called party directory numbers to geographic location, substantially as described in relation to FIG. 1. Hence, location of a particular called station may be determined based on its directory number. Having determined the location of the called party, the terminating switch can determine whether the location is within a security risk area 110 and restrict call terminations in the security risk area as may be appropriate.

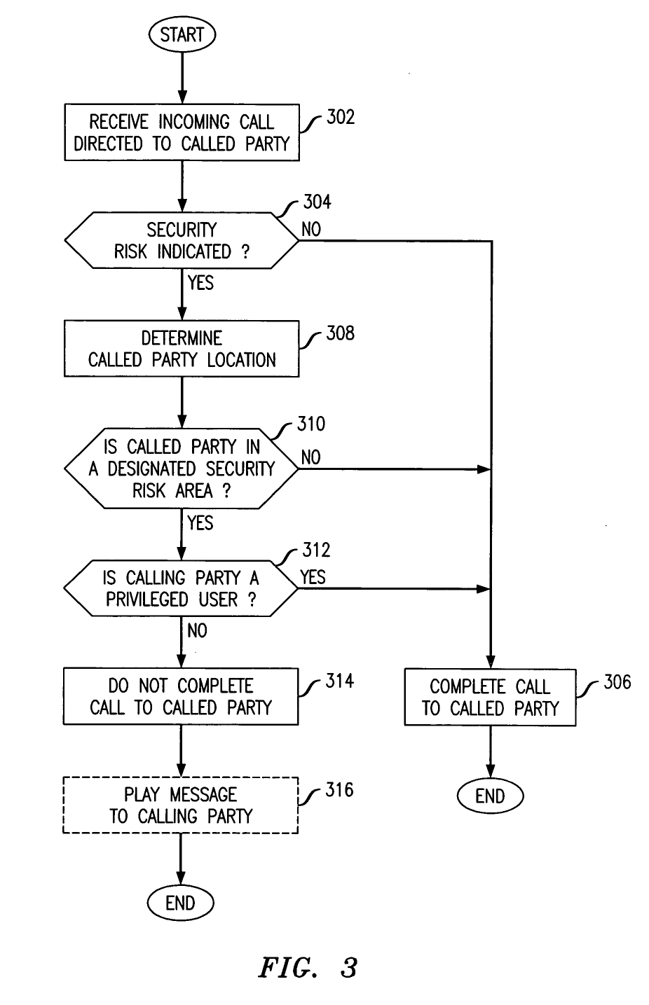

FIG. 3 is a flowchart of a method exercised by a terminating switch 106 to restrict call terminations within the designated security risk area 110. In one embodiment, the steps of FIG. 3 are implemented, where applicable, by software routines executed within the terminating switch 106 and/or SCP 120 such as described in relation to FIG. 1. Alternatively, a terminating switch may implement the steps of FIG. 3 without relying on an SCP, such as described in relation to FIG. 2. Generally, the steps of FIG. 3 may be implemented on any computer-readable signal-bearing media residing within or remote from the terminating switch. The computer-readable signal-bearing media may comprise, for example and without limitation, floppy disks, magnetic tapes, CD-ROMs, DVD-ROMs, hard disk drives or electronic memory. The computer-readable signal-bearing media store software, firmware and/or assembly language for performing one or more functions relating to the steps of FIG. 3.

At step 302, the terminating switch receives an incoming call from a calling station directed to a directory number of a called station 104, which called station is served by the terminating switch and may reside within or outside a designated security risk area 110. The terminating switch may also serve the calling station, in which case the terminating switch is both an originating and terminating switch; or the calling and called station may be served by different switches. The incoming call may comprise, without limitation, a voice, video and/or data call, electronic mail, page or SMS message. The source of the incoming call may comprise, without limitation, a wireline or wireless telephone, fax machine, personal digital assistant (PDA), computer-and the like; and the called party may comprise, without limitation, a traditional POTS phone, voice over IP (VoIP) phone, pay phone, fax or the like.

Depending on the relative location of the calling and called station, the directory number typically comprises 7 or more digits sufficient to identify the called station 104. For example, when both the calling and called station are within an area served by the same area code (i.e., a local call), a set of seven dialed digits comprising a three digit office code and a four digit line code will suffice to identify the called station. As another example, when the calling and called station are not in the same area code but are within the same LATA boundary (i.e., an intra-LATA call), a set of 10 dialed digits comprising a three digit area code, three digit office code and a four digit line code is necessary to identify the calling station. As yet another example, when the called party and the calling party reside in different LATAs and reside in different area codes or countries a DN greater than 10 digits must be dialed. In such case, the DN comprises a country code of 1-3 digits, followed by a three digit area code, a three digit office code and a four digit line code.

At step 304, the terminating switch determines whether a security risk is indicated within its serving area. In one embodiment, the terminating switch is informed whether a security risk is indicated by the presence or absence of an emergency condition indicator communicated from the network operations center 112. The emergency condition indicator may be communicated separately or coincident to processing the incoming call. The terminating switch makes a threshold decision on how to process the incoming call based on whether or not a security risk is indicated. If a security risk is not indicated, the terminating switch at step 306 completes the call to the called station as normal. If a security risk is indicated, the terminating switch proceeds to step 308.

At step 308, the terminating switch determines the called party location. In one embodiment, as described in relation to FIG. 1, the terminating switch 106 queries an SCP 120 to determine the location of the called station. Responsive to the query, the SCP consults a network database 126, such as a 9-1-1 database, to determine the location of the called station and so informs the terminating switch. Alternatively, as described in relation to FIG. 2, the terminating switch 106 independently consults the network database 126 to determine the location of the called station. In either case, the location of the called station is determined based on its directory number by identifying a location of the called party number mapped to the directory number in the database 126.

At step 310, after having determined the location of the called station, the terminating switch (or alternatively, the terminating switch in conjunction with the SCP) determines whether the called station location corresponds to a cell within the designated security risk area 110. The terminating switch makes a decision on how to process the incoming call based on whether or not the called station is within the security risk area 110. If the called station is not within the security risk area, the terminating switch proceeds to step 306 and completes the call to the called station as normal.

If the called station is in the security risk area 110, the terminating switch at step 312 determines whether the calling party is a privileged user. For example, the calling party may comprise a GETS or WPS user. If the calling party is a privileged user, the terminating switch proceeds to step 306 and completes the call to the called station (e.g., station “G”) even though the called station is in the security risk area. However, if the calling party is not a privileged user, the terminating switch at step 314 prevents the call from being completed to the called station (e.g., station “T”) so as to preclude the possibility that the call will be used to detonate a bomb.

Optionally, at step 316, if the call is not completed because the call is directed to the security risk area and the calling party is not a privileged user, the terminating switch may play an announcement to the caller stating that calls cannot be completed at this time. Alternatively, rather than playing an announcement, the terminating switch may cause the incoming call to be redirected to voice mail of the called party. However, such an operation is normally followed by a message to the called party indicating that a message is waiting. There is a risk that such a message waiting indication could trigger a bomb. Accordingly, in one embodiment, the terminating switch suppresses the message waiting indication for so long as an emergency condition is indicated that encompasses the called station location.

It is noted, while embodiments of the present invention operate to restrict call terminations directed to a designated security risk area that are originated by non-privileged users, the invention contemplates permitting call originations from non-privileged users (as well as privileged users) within the security risk area. In such manner, the threat of triggering a bomb is minimized with minimal disruption to the general population. Citizens will still be able to use their wireline terminals to call wireline destinations such as 9-1-1 or their homes or, via a gateway, they may call mobile terminals located outside of the affected area. As a further benefit, since the terminating switch is not shut down, wireline terminals (e.g., station “A”) residing outside of the affected area remain operational.

The present invention may be embodied in other specific forms without departing from its spirit or essential characteristics. The described embodiments are to be considered in all respects only as illustrative and not restrictive. For example, although described in connection with a bomb threat, embodiments of the present invention could be applied to other emergency situations that might occur in which a ringing wireline terminal could deleteriously impact the situation either through triggering of another device, or from the ringing of the terminal itself, as for example, in a hostage situation. The scope of the invention is, therefore, indicated by the appended claims rather than by the foregoing description. All changes that come within the meaning and range of equivalency of the claims are to be embraced within their scope.

What is claimed is:

1. A method comprising:
receiving an incoming wireline call from a calling party directed to a called party;
determining a location of the called party relative to a security risk area;
determining whether the calling party is a privileged user; and
preventing termination of the call if the called party is within the security risk area and the calling party is not a privileged user.

2. The method of claim 1, further comprising a step of completing the call if the calling party is a privileged user.

3. The method of claim 1, further comprising a step of completing the call if the called party is not within the security risk area.

4. The method of claim 1, wherein the step of receiving an incoming wireline call comprises receiving dialed digits defining a directory number of a called party wireline device, the step of determining a location of the called party relative to the security risk area comprising:
determining, based on the directory number, a location of the called party device; and
comparing the location of the called party device to a designated security risk area.

5. The method of claim 4, performed by a terminating switch operably connected to an Intelligent Network Service Control Point (SCP), the terminating switch querying the SCP to determine a location of the called party device.

6. The method of claim 4, performed by a terminating switch consulting a database to determine a location of the called party device.

7. The method of claim 1, wherein the step of determining whether the calling party is a privileged user comprises determining whether the calling party is a WPS or GETS user.

8. A method comprising the steps of:
in response to a determination that an emergency situation is present or imminent within a critical area defining a security risk area, sending indicia of the emergency situation to one or more switching elements so as to restrict wireline call terminations directed to the security risk area from non-privileged users but which does not restrict wireline call terminations from privileged users.

9. A system comprising:
means for identifying a security threat condition corresponding to a security risk area and alerting one or more switching elements of the threat condition; and
one or more switching elements operable responsive to the threat condition to prevent wireline call terminations directed to the security risk area from non-privileged users and allow call terminations directed to security risk area from privileged users.

10. An article comprising:
one or more computer-readable signal-bearing media; and
means in the one or more media for preventing wireline call terminations directed to a designated security risk area from non-privileged users and allow wireline call terminations directed to the security risk area from privileged users.

11. The article of claim 10, wherein the means in the one or more media for preventing wireline call terminations includes:
means for determining that an incoming call originated from a calling party is directed-to a called party device within the security risk area;
means for determining whether the calling party is a privileged user; and
means for preventing termination of the call if the called party is within the security risk area and the calling party is not a privileged user.

12. The article of claim 10, further including means for completing the call if the calling party is a privileged user.
